(19) United States
(12) Patent Application Publication
(10) Pub. No.: US 2005/0082396 A1
(43) Pub. Date: Apr. 21, 2005

(54) Showering device

(76) Inventor: Andreas Wawrla, Widnau (CH)

Correspondence Address: WILLIAM M HANLON, JR;YOUNG & BASILE, PC, 3001 WEST BIG BEAVER ROAD, SUITE 624, TROY, MI, 48084-3107, US

(21) Appl. No.: 10/951,010

(22) Filed: Sep. 27, 2004

(30) Foreign Application Priority Data
Oct. 1, 2003 (DE) 20315306.5

(51) Int. Cl. A01G 27/00; B67D 5/08; B05B 3/04; B05B 3/16

(52) U.S. Cl. 239/569; 239/71; 239/67

(57) ABSTRACT

A shower device has a showerhead, which is supplied with water via a and a mixer fitting. Provided on the end of the feed line on the showerhead remotely-controlled control valve, the actuating member of which is in the vicinity of the mixer fitting.

### BACKGROUND OF THE INVENTION

The invention relates to a shower device comprising a showerhead, a feed line leading thereto and a control fitting connected to the feed line and spaced apart from the showerhead.

Shower devices of this type can be found in various forms. The feed line is generally laid under plaster and the control fitting is typically located in showers at chest level. However, similar shower devices are also known on bathtubs, wherein the control fitting has a further outlet, with which the bathtub can be directly filled, and wherein the feed line is a flexible hose.

Mixers which allow the quantity and temperature of the water fed to the showerhead to be adjusted are generally used as control fittings. Thermostat-controlled mixers are frequently also used.

After a long period without use, viruses or bacteria may become established in the feed line in shower devices of this type, as in air conditioning systems. The health of users is put at risk thereby.

### SUMMARY OF THE INVENTION

Owing to the present invention, a shower device is to be developed such that the risk of such adverse effects on health is eliminated.

This object is achieved according to the invention by a shower device with the features discussed hereafter.

In the shower device according to the invention, the feed line is constantly free of air and filled with clean water right up to the direct vicinity of the showerhead. No bacteria and viruses can therefore become established here. Nevertheless, actuation of the shower from a place with good access is ensured.

Advantageous developments of the invention are the subject of sub-claims.

In a shower device, the water quantity can be adjusted and the water temperature optionally adjusted and the control valve opened and closed substantially from the same place. This makes handling easier for the user.

If a solenoid valve is used as the control valve, a simple control line which only requires a small amount of space can be used. This line may also easily be laid over relatively large distances when installing a bath or a shower.

The development of the invention means that the solenoid valve does not need to have a large through-flow cross-section. Solenoid valves of this type can be commercially obtained economically. The supply of energy to a small solenoid valve is also simple and, in particular, possible from batteries or other low-capacity power sources.

In a shower device, the remotely-controlled control valve may also be actuated without an electric power source. The energy for adjusting the control valve is taken from the pressure energy of the controlled water flow or produced by muscle power.

The development of the invention is therefore advantageous, in this instance, in view of a simple connection of the showerhead and simple laying of the feed line and control line.

In a shower device, only one single line needs to be laid to the showerhead.

The design of the invention is distinguished by a mechanically particularly simple construction.

### BRIEF DESCRIPTION OF THE DRAWINGS

The invention will be described in more detail hereinafter with the aid of embodiments with reference to the drawings, in which:

FIG. 1 shows a schematic view of a shower device;

FIG. 2 shows a block diagram of a modified control valve arrangement which can be used instead of a showerhead control valve shown in FIG. 1;

FIG. 3 shows an axial view of a practical embodiment of a control valve arrangement according to FIG. 2;

FIG. 4 shows a transverse section through a flexible hose with an integrated control line for a showerhead control valve;

FIG. 5 shows a similar view to FIG. 1, in which a fluid-actuated showerhead control valve is depicted;

FIG. 6 shows a transverse section through a preferred design of a double connecting line to the showerhead which has a feed water duct and a control pressure duct; and

FIG. 7 shows a similar view to FIG. 1, in which a hydro-mechanically actuated showerhead control valve is shown.

### DETAILED DESCRIPTION OF THE PREFERRED EMBODIMENT

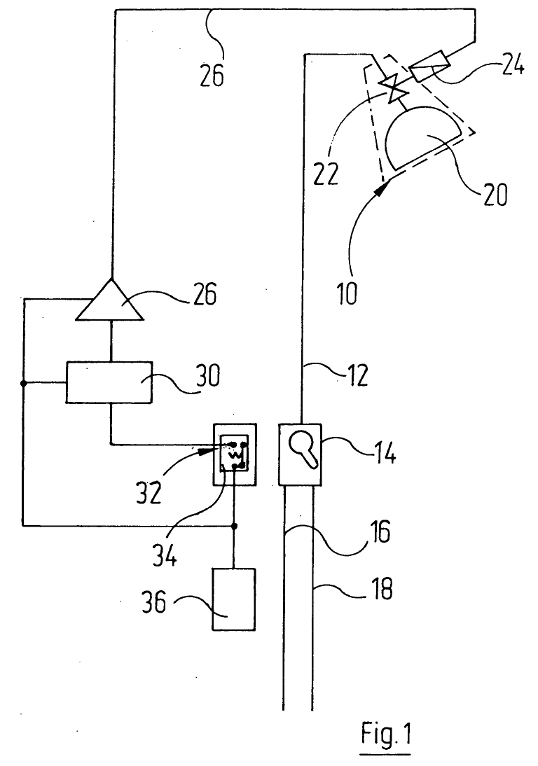

FIG. 1 shows a showerhead, denoted throughout by 10, which is connected via a feed line 12 to a mixer fitting 14 which is shown as a one-lever mixer. The mixer fitting 14 is connected on the input side to a cold water line 16 and a hot water line 18.

The showerhead 10, apart from the actual shower part 20, comprises a control valve 22 which is inserted into the duct of the showerhead housing 10 leading to the showerhead 20. The control valve 22 is shown as a solenoid valve. Its control magnet 24 is connected via a line 26 to the output of a booster 28, which is controlled from the output of a single-digit binary counter 30. The input of the binary counter 30 is connected to the output of a momentary contact switch 32, which has a large actuating plate 34.

An input of the momentary contact switch 32 is connected to the output of a voltage source 36. This may be a battery, a photoelectric device, a fuel cell or else a damp-proof mains supply unit operated by mains voltage. This mains supply unit is simultaneously used for the energy supply of the binary counter 30 and the booster 28 and any further electrical components of the shower device which are not shown in the drawing, such as displays about the operating state etc.

The mixer fitting 14, unlike otherwise conventional mixer fittings, is formed such that a restricted connection remains between the cold water line and the feed line 12 even in the “closed position” of the mixer fitting 14. The inlet of the control valve 22 is thus constantly loaded with pressurised water.

The shower device is operated according to FIG. 1 as follows:

The user adjusts the desired throughput and the desired temperature at the mixer fitting 14. He then actuates the actuating plate 34 of the momentary contact switch 32, whereby the output signal of the one-digit binary counter changes. An activation signal for the control magnet 24 is correspondingly received at the output of the booster 28, so that the control valve 22 opens. Water is now delivered from the shower part 20 at the desired temperature and in the quantity adjusted at the mixer fitting 14.

To finish showering, the actuating plate 34 is simply pressed again, with the result that the output signal at the binary counter 30 disappears as does the feed signal for the control magnet 24 which is provided at the output of the booster 28. However, a pressure is maintained in the feed line 12. This line thus remains completely full of water so it is not possible for germs to form.

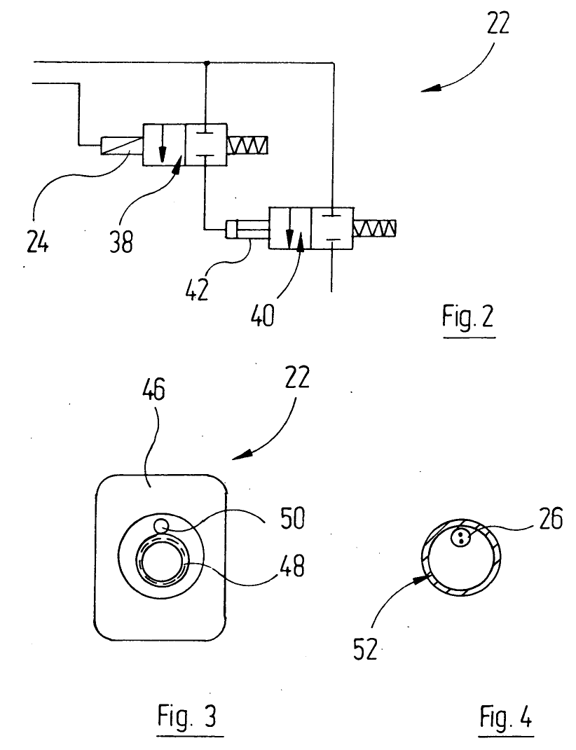

FIG. 2 shows a modified control valve 22 which has a pre-control valve 38 and a main control valve 34.

The pre-control valve 38 is resiliently biased into the closed position and can be brought into the open position by exciting the control magnet 24. The main valve 40 is resiliently biased into the closed position and comprises a control cylinder 42 which is connected to the working aperture of the pre-control valve 38 and moves into the open position counter to the spring biasing when the main control valve 40 is subjected to pressure.

FIG. 2 shows the control line 26 and the feed line 12 closely adjacent. In practice, these two lines will be connected to form a unit which can be handled in one piece, for example by gluing, welding or mechanically (for example pressing a flexible control cable into a groove provided in the external face of the feed line 12).

FIG. 3 shows an axial view of the connecting end of a practical embodiment for a control valve 22.

A pipe nipple 44 made of metal on the inlet side is injected into a valve housing 46. The pipe nipple 44 has a standard thread which can be screwed into a standard thread of the feed line 12.

A connecting piece 48 of the housing adjacent to the pipe nipple 44 has an electrical contact 50 which is designed to be inherently resilient or is biased by a spring in the axial outward direction. The contact 50 produces the connection to the line 26 via a space-fixed counter-contact, not shown in the drawing.

The valve arrangement shown in FIG. 2 is housed in the interior of the valve housing 46.

At its second end face to be imagined behind the plane of the drawing in FIG. 3, the control valve 22 has a pipe nipple 44 on the outlet side, which is provided with a standard thread allowing standard screw heads to be screwed on.

Any standard showerheads can therefore be used with the control valve 22 shown in FIG. 3, it being ensured in turn that no viruses or bacteria can become established in the feed line.

The control valve 22 shown in FIG. 3 can also be used in connection with a hand shower. In this case, the control line 26 designed as a flexible cable is then arranged inside a flexible feed hose 52. The conventional connection fittings carried by the feed hose 52 are produced from plastics material and carry flanges with contacts, which cooperate with the contact 50 of the control valve 22 or a space-fixed contact, not shown in the drawing, which is provided during the shower connection of the mixer fitting 14.

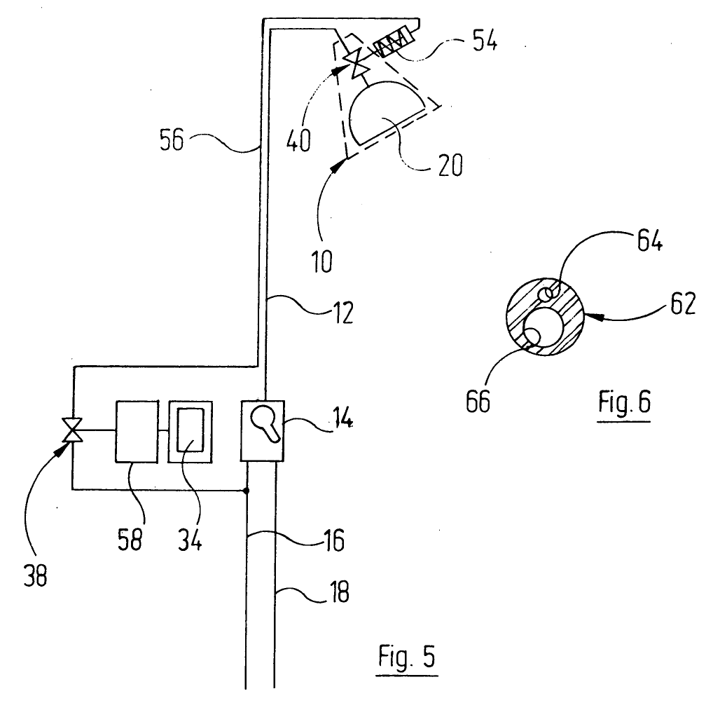

FIG. 5 shows a modified embodiment with fluidic actuation of the control valve 22. Parts of this shower device, which have already been described with reference to FIG. 1, are again provided with the same reference numerals and are not described again hereinafter in detail.

The control valve 22 now has a control cylinder 54 which logically corresponds to the control cylinder 42 of FIG. 2. The pre-control valve 38 shown in FIG. 2 is now arranged remote from the showerhead, however, and connected via a fluidic control line 56 guided up close to the mixer fitting 14. The pre-control valve 38 is located there in the direct vicinity of the mixer fitting 14. The pre-control valve 38 is not a solenoid valve now but a mechanically actuated valve. Actuation takes place from the actuating plate 34 which is connected mechanically to the control member of the pre-control valve 38 via a two-position gearing 58. The two-position gearing 58 may be designed in a similar manner to that known from the adjustment of ballpoint pen refills. With each actuation of its entry member, the position of the exit member is changed between two different end positions.

The embodiment according to FIG. 5 operates exactly like that according to FIG. 1. However, no electrical devices of any kind are required.

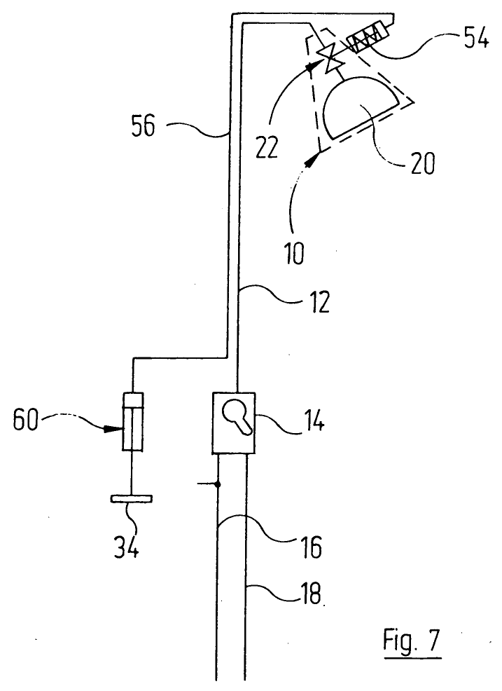

In a further modification of the embodiment according to FIG. 5, in FIG. 7 a transmitter cylinder 60 is provided at the end of the control line 56 adjacent to the mixer fitting. The control line 56 and the operating spaces of the actuating cylinder 54 and the transmitter cylinder 60 are filled with a closed volume of an actuating fluid which may be water or a hydraulic oil. The main valve 40 is actuated by means of a displaceable actuating member 34 which is mechanically coupled to the piston of the transmitter cylinder 60.

FIG. 6 shows a transverse section through a two-duct pipe, which may be produced from extruded aluminium or an extruded aluminium alloy or an extruded plastics material. This two-duct pipe 62 has a control duct 64 which forms the control line 56, and a water duct 66 which forms the feed line 12.

The entire installation can thus be housed between the actuating site and the fixing site of the showerhead 10 in a single slot in a wall.

Instead of the control valve 22 shown in FIG. 1, a mono-stable solenoid valve may also be used. This is preferably used when the voltage source 36 is a mains supply unit or can be fed from such a unit.

If the voltage source 36 is, on the other hand, a battery or an accumulator, a bi-stable solenoid valve is preferably used as the control valve 22.

The electrical actuation of the control valve 22 was described above with reference to the momentary contact switch 32.

It is obvious that, instead of the momentary contact switch 32, any other detector can be used which can be operated by a user for the targeted output of an electric signal. These primarily include infrared light barriers, optical sensors, and other presence detectors such as radar sensors, ultrasound sensors etc.

1. Shower device comprising a showerhead, a feed line leading thereto and a control fitting connected to the feed line and spaced apart from the showerhead, wherein the feed line has a remotely-controlled control valve in the vicinity of its end on the showerhead side.

2. Shower device according to claim 1, wherein an actuating part for the control valve is arranged in the vicinity of the control fitting or is integrated therein.

3. Shower device according to claim 1 wherein the control valve comprises a control magnet.

4. Shower device according to claim 3, wherein the control magnet actuates a pre-control valve, the working aperture of which is connected to a control cylinder of a main control valve.

5. Shower device according to claim 1, wherein the control valve has an actuating cylinder connected via a control line to a pre-control valve or a transmitter cylinder, which can be actuated by the actuating part.

6. Shower device according to claim 5, wherein the control line and the feed line are combined to form one unit.

7. Shower device according to claim 6, wherein the control line and the feed line are at least partially formed by a pipe which has two ducts.

8. Shower device according to claim 1, wherein a control part of the control valve is connected via a mechanical or fluidic force transmission route to an actuating member adjacent to the mixer fitting.
